(19) United States
(12) Patent Application Publication
(10) Pub. No.: US 2009/0010207 A1
(43) Pub. Date: Jan. 8, 2009

(54) METHOD AND SYSTEM TO AUGMENT LEGACY TELEMETRY SYSTEMS AND SENSORS

(76) Inventor: Amin Rashid Ismail, Orlando, FL (US)

Correspondence Address: RHONDA L. COPLEY, 4700 MILLENIA BLVD., SUITE 175, ORLANDO, FL, 32839, US

(21) Appl. No.: 12/164,001

(22) Filed: Jun. 28, 2008

Related U.S. Application Data
(60) Provisional application No. 60/947,530, filed on Jul. 2, 2007.

(51) Int. Cl. H04Q 7/00

(52) U.S. Cl. 370/328

(57) ABSTRACT

A method and system to extend the reach and improve the reliability of legacy telemetry systems. A first node transmits a plurality of data to a base station directly or by using a second node and a plurality of transmission nodes. A consolidation node collects transmissions of the plurality of data from the plurality of transmission nodes, thereby extending the reach of the network.

### BACKGROUND OF THE INVENTION

An existing telemetry system comprises of a plurality of sensors, the plurality of sensors use a wired transmission protocol to communicate a plurality of data. The wired transmission protocol communicates the plurality of data over a limited range, and has shortcomings such as lost messages, high error rates and addressing limitations.

A need is felt to increase the range of the plurality of sensors, the plurality of sensors would consume less power, and provide a reliable communication.

### BRIEF DESCRIPTION OF THE DRAWINGS

FIG. 1 denotes an embodiment of the invention depicting the block diagram of the communication system.

FIG. 2 denotes an embodiment of the invention depicting a communication mechanism in an enhanced telemetry communication system.

FIG. 3 denotes an embodiment of the invention depicting an overall communication flow to enhance a telemetry system.

### DESCRIPTION OF THE PREFERRED EMBODIMENT

A communication system comprising of a plurality of communication nodes using an integrated ad hoc mesh networking, the plurality of communication nodes comprising a first software, can help overcome the shortcomings of a legacy telemetry system. In an embodiment of the invention the plurality of communication nodes would comprise one or more of a plurality of tags, a plurality of micro electro-mechanical systems (MEMS) sensors and a plurality of wireless radio sensors. The plurality of wireless sensors could form a wireless sensor network (WSN). The one or more of the plurality of tags, the plurality of micro electro-mechanical systems (MEMS) sensors and the plurality of wireless radio sensors would perform a communication with a plurality of base stations using an ad hoc networking. The communication would be facilitated by one or more of a plurality of transmission nodes and a plurality of consolidation nodes, the one or more of a plurality of transmission nodes and a plurality of consolidation nodes comprising a second software and a third software respectively. The communication would be implemented by the first software, the second software, and the third software. The first software, the second software, and the third software could comprise of a plurality of routing tables.

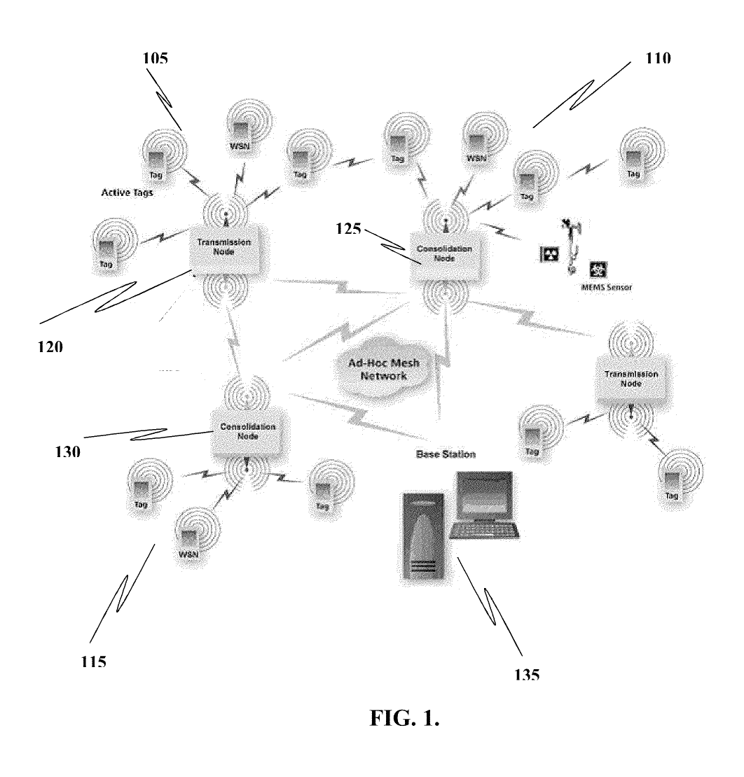

In an embodiment of the invention (100), as depicted in FIG. 1, one or more sensors (105, 110, 115) would collect a plurality of data. The one or more sensors (105, 110, 115) would comprise one or more of a plurality of tags, a plurality of micro electro-mechanical systems (MEMS) sensors and a plurality of wireless radio sensors. The plurality of sensing devices would further comprise a first communication software (not shown in figure). The plurality of data would be communicated to a plurality of transmission nodes (120) using the first communication software and a first communication mechanism. The plurality of transmission nodes (120) comprise of a second communication software (not shown in figure). The plurality of transmission nodes (120) would further transmit the plurality of data to a plurality of consolidation nodes (125, 130) using the second communication software and a second communication mechanism. The plurality of consolidation nodes (125, 130) would comprise a third communication software (not shown in figure). The plurality of consolidation nodes (125, 130) would transmit the plurality of data to a base station (135) using the third communication software and a third communication mechanism. The plurality consolidation nodes (125,130) help in consolidating the plurality of data transmitted by the plurality of transmission nodes (120), thereby increasing a range of transmission in the telemetry communication system. The first communication software, second communication software and the third communication software would comprise a plurality of routing tables.

In an embodiment of the invention, the first communication mechanism could comprise of one of a direct communication mechanism, an indirect communication mechanism, a heartbeat signal and a handshake signal from a first node forming part of the plurality of sensing devices (105, 110, 115) and the plurality of transmission nodes (120). In case a direct data communication mechanism between the first node forming part of the plurality of sensing devices (105, 110, 115) and the plurality of transmission nodes (120) cannot happen, the indirect communication mechanism shall be used. In an embodiment of the invention, the indirect communication mechanism comprises of the first node transmitting the plurality of data to the plurality of transmission nodes through a second node, the second node forming part of the plurality of sensing devices (105, 110, 115). The second node would be a node that is identified by using the routing tables forming part of the first communication software. The first communication software would enable the direct transmission mechanism and the indirect transmission mechanism. The heart beat signals transmission would denote that the one or more of the plurality of tags, the plurality of micro electro-mechanical systems (MEMS) sensors and the plurality of wireless radio sensors forming part of the plurality of sensors are alive.

The communication between the first node and the second node could be based on an IEEE (The Institute of Electrical and Electronic Engineers) standard 802.15.4 radio protocol. The standard 802.15.4 radio protocol could be a ZigBee protocol. The 802.15.4 protocol, and the ZigBee protocol are known in the art.

In an embodiment of the invention, the first communication mechanism, the second communication mechanism and the third communication mechanism could use one of a ultra high frequency (UHF), and a very high frequency (VHF) based transmission, and a legacy radio communication as a network transmission mode. The UHF transmission, the VHF transmission and the legacy radio communication are known in the art.

The plurality of transmission nodes (120) and the plurality of consolidation nodes (125, 130) could comprise of a radio frequency identifier (RFID) reader, a communication radio and an input-output (I-O) section. The I-O section could be based on an analog or a digital process.

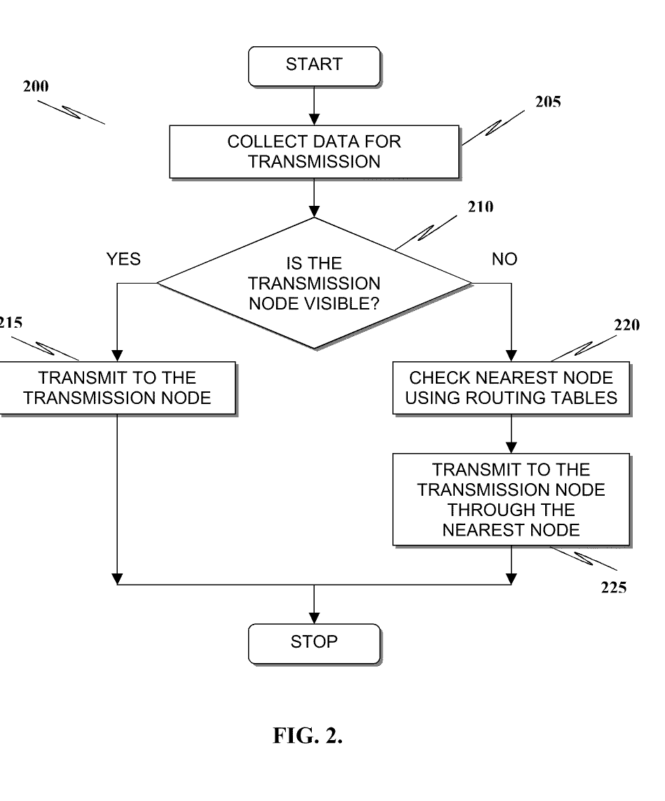

FIG. 2 depicts a flowchart (200) denoting an embodiment of a typical scenario of the first transmission mechanism during transmitting a plurality of data from a first node to the base station (135). A first node collects the plurality of data to be transmitted (step 205), and checks (step 210) whether a transmission node (120) is visible. In case the transmission node is visible, the first node transmits the data to the transmission node as depicted in step 215. In case the transmission node is not visible, the first node refers to a routing table (step 220), the routing table forming part of a first communication software, to determine a second node. The second node is a nearest node to the transmission node (120). The first node then transmits the data to the second node, as depicted in step 225. The transmission node, in turn, transmits the data to the base station (135) through a consolidation node (125, 130).

The use of the first communication software, the second communication software and the third communication software at the plurality of sensing devices (105, 110, 115), the plurality of transmission nodes (120) and plurality of consolidation nodes (125, 130) provide a facility of reliable and lossless transmission. This in turn enables high availability transmission network overcoming the drawbacks of legacy systems.

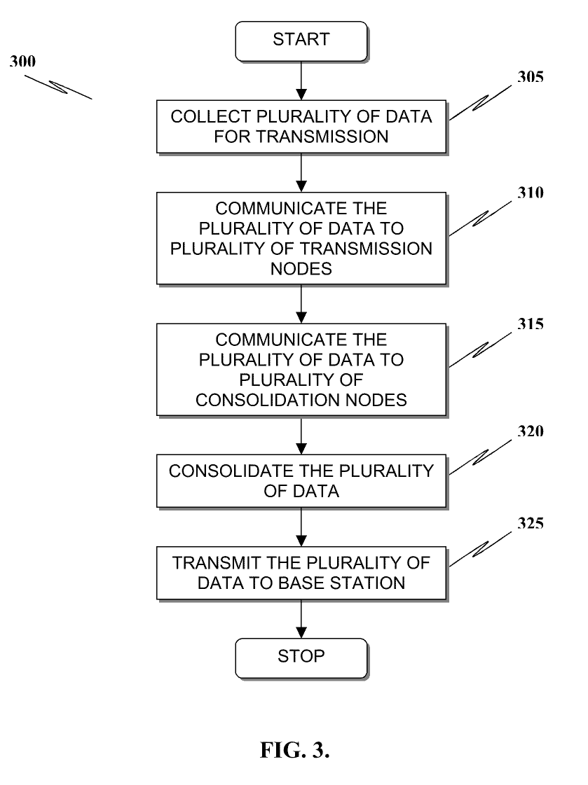

FIG. 3 denotes an embodiment (300) of the invention depicting an overall communication flow to enhance a telemetry system. The method comprises of a step (305) depicting collecting a plurality of data using one or more sensors. The one or more sensors shall comprise of a first communication software. The one or more sensors shall communicate the plurality of data (as depicted in step 310) to one or more transmission nodes using the first communication software and a first communication mechanism. The one or more transmission nodes would comprise a second communication software. The one or more transmission nodes shall communicate the plurality of data (step 315) to one or more consolidation nodes using the second communication software and a second communication mechanism. The one or more consolidation nodes shall comprise a third communication software. The one or more consolidation nodes shall consolidate (step 320) the plurality of data received from the one or more transmission nodes for further communicating the consolidate data to a base station using a third communication mechanism (as depicted in step 325).

1. A method to enhance a telemetry system, the method comprising:
collecting a plurality of data using one or more sensors, the one or more sensors further comprising of a first communication software,
communicating the plurality of data to one or more transmission nodes using the first communication software and a first communication mechanism, the one or more transmission nodes further comprising a second communication software,
communicating the plurality of data to one or more consolidation nodes using the second communication software and a second communication mechanism, the one or more consolidation nodes further comprising of a third communication software,
consolidating the plurality of data using the third communication software to generate a consolidated data,
transmitting the consolidated data to a base station using a third communication mechanism.

2. The method of claim 1, wherein the first communication mechanism, the second communication mechanism, the third communication mechanism comprises one of a direct communication mechanism, an indirect communication mechanism, a heartbeat signal, a handshake signal.

3. The method of claim 2, wherein the first communication mechanism, the second communication mechanism, the third communication mechanism comprises a ultra high frequency (UHF) communication, a very high frequency (VHF) communication, and a radio communication.

4. The method of claim 3, wherein the first communication software, the second communication software, the third communication software comprises one or more routing tables.

5. The method of claim 4, wherein the one or more sensors comprises a tag, micro electro-mechanical system (MEMS) sensor, and radio sensor.

6. A system to enhance a telemetry system communication, the system comprising:
one or more sensors to collect a plurality of data and transmit the plurality of data to one or more transmission nodes using a first communication software and a first communication mechanism,
the one or more transmission nodes to further communicate the plurality of data to one or more consolidation nodes using a second communication software and a second communication mechanism,
the one or more consolidating nodes to further consolidate the plurality of data to obtain a consolidated data and transmit the consolidated data to a base station using a third communication software and a third communication mechanism.

7. The system of claim 6, wherein the first communication software, the second communication software, the third communication software comprises one or more routing tables.

8. The system of claim 7, wherein the one or more sensors comprises a tag, micro electro-mechanical system (MEMS) sensor, and radio sensor.

9. The system of claim 8, wherein the one or more transmission nodes, the one or more consolidation nodes comprises of a radio frequency identifier (RFID) reader, a communication radio and an input-output (I-O) section.

10. The system of claim 9, wherein the I-O section comprises an analog process and a digital process.
